(19) United States
(12) Patent Application Publication
(10) Pub. No.: US 2006/0119293 A1
(43) Pub. Date: Jun. 8, 2006

(54) Lamp load-sharing circuit

(76) Inventors: Chun-Kong Chan, Hsi Chih City (TW); Jeng-Shong Wang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/002,339

(22) Filed: Dec. 3, 2004

(51) Int. Cl. H05B 41/24

(52) U.S. Cl. 315/312

(57) ABSTRACT

In a lamp load-sharing circuit, winding coils on one side of a plurality of transformers are connected to a plurality of lamps, and winding coils on the other side of the transformers are serially connected together to form a closed loop. The same current flows through the winding coils which are serially connected together to form a closed loop. Through the electromagnetic induction characteristic of the transformers, equal working currents are generated in the lamps connected to the winding coils on the other side of the transformers.

### BACKGROUND OF THE INVENTION

1. Field of the Invention

The present invention relates to a lamp load-sharing circuit and, more particularly, to a lamp load-sharing circuit making use of the connection relation between a plurality of transformers and a plurality of lamps to regulate the balance of current between the lamps.

2. Description of Related Art

Due to the progress of technology and customer demand, the size of LCD panels is continually increasing so that a single lamp is unable to illuminate the entire panel. Two or more lamps thus are required. In order to ensure the uniformity of brightness of an LCD panel, it is necessary to regulate the current of each lamp momentarily to equalize the current flowing through each lamp. Because the cold cathode fluorescent lamp (CCFL) is highly instable and has a negative impedance, it is difficult to keep the impedance of each lamp consistent. The impedance of each lamp thus changes and the current of each lamp can't be equalized. The inequality of the current of each lamp results in irregular brightness of each lamp. Moreover, the lifetime of a lamp with an excessively large current is shortened to cause different aging rates for each lamp.

FIG. 1 shows a simple circuit, in which a conventional differential ballast is used to regulate the currents of two lamps. The circuit comprises a transformer 12 having a first coil 121 and a second coil 122. One end of the first coil 121 is connected to an AC power source 10, and the other end of the first coil 121 is connected to a first lamp 141. The other end of the first lamp 141 is connected to a reference potential G. One end of the second coil 122 is connected to the AC power source, and the other end of the second coil 122 is connected to a second lamp 142. The other end of the second lamp 142 is connected to a reference potential G. The AC power source 10 forms a differential ballast through the first coil 121 and the second oil 122 of the transformer 12 to provide stable currents I₁ and I2 for the first lamp 141 and the second lamp 142, hence accomplishing the effect of balancing the currents flowing through the first and second lamps 141 and 142.

Reference is made to FIG. 2 as well as FIG. 1. A magnetic core 120 comprises two side columns A1 and A2 and two shoulder columns A3 and A4. When the currents I₁ and I₂ are equal, the currents flowing through the first coil 121 and the second coil 122 are also equal. Moreover, the magnetomotive force generated at the first coil 121 by the current I₁ is equal to that generated at the second coil 122 by the current I₂. That is, the magnetomotive force in the side column A1 and that in the side column A2 cancel each other out. Therefore, there is no interconnected magnetic flux in the shoulder columns A3 and A4. The magnetic fluxes Φ1 and Φ2 in the side columns A1 and A2 can form closed loops via external air gaps, respectively. Because the magnetic resistance of the air gap is very high, the inductance effect caused by this loop can generally be neglected.

Reference is made to FIG. 3 as well as FIG. 1. When the current I₁ of the first lamp 141 and the current I₂ of the second lamp 142 are not equal, the magnetomotive force generated at the first coil 121 by the current I₁ and that generated at the second coil 122 by the current I₂ are not equal. In other words, the magnetomotive forces in the side columns A1 and A2 are not equal. The difference between them is applied to a low-resistance loop formed by the side column A1, the side column A2, the shoulder column A3, and the shoulder column A4 to produce a large magnetic flux Φ. The magnetic flux Φwill generate a correction voltage ΔV across the ends of the first coil 121 and the second coil 122 by induction. This correction voltage ΔV will force the current I₁ of the first lamp 141 and the current I₂ of the second lamp 142 to restore to the balanced and equal state.

FIG. 4 shows a conventional circuit making use of a differential ballast to regulate the currents of a plurality of lamps. The circuit comprises a plurality of transformers 12 each having a first coil 121 and a second coil 122. One end of each of the first coils 121 is connected to a reference potential G; the other end is connected to a first lamp 141. The other end of each of the first lamp 141 is connected to an AC power source 10. One end of each of the second coils 122 is connected to the reference potential G; the other end is connected to a second lamp 142. The other end of each of the second lamp 142 is connected to the AC power source 10. The AC power source 10 forms a differential ballast through the first coils 121 and the second coils 122 of the transformers 12 to provide stable currents I₁ and I₂ for the first lamps 141 and the second lamps 142, hence accomplishing the balanced effect of the currents I₁ and I₂ flowing through the first lamp 141 and the second lamp 142 connected with the same transformer 12. However, the balanced effect of current can't be achieved for the first and second lamps connected with different transformers 12.

FIG. 5 shows another conventional circuit making use of a differential ballast to regulate the currents of a plurality of lamps. This embodiment is exemplified with two lamps. Two lamps 31 and 31 are connected in shunt. The high-voltage ends of the two lamps 31 and 31 are connected to an AC power source 10 via a differential ballast component 39. The differential ballast component 39 can generate a correction voltage in proportional to the mismatch between the currents I₃₁ and I₃₂ of the lamps 31 and 32. This correction voltage can be superimposed to a common drive voltage. The corrected drive voltage can properly adjust the currents I₃₁ and I₃₂ of the lamps 31 and 32 to achieve uniform distribution. Although this circuit can ensure that the currents of the lamps are equal, the structure thereof generally includes magnetic coils and coil holders of special shapes. These magnetic coils and coil holders are not standardized products and cause inconvenience in the arrangement of material and cost control.

FIG. 6 shows another conventional circuit making use of a differential ballast to regulate the currents of a plurality of lamps. A plurality of differential ballast components (T1, T2, T3, T4, T5, T6, T7) are connected to an AC power source 10 in a tree structure. Currents are bypassed to a plurality of lamps (L1, L2, L3, L4, L5, L6, L7, L8) based on the layered and bypass principle to accomplish balance of current. Because the principle is the same as that described in FIG. 5, it is not further described here.

The above conventional circuits for regulation of lamp currents have a common drawback in that they can only be used for the balance of current between two lamps, but can't be used for the balance of current of an odd number of lamps. Moreover, as shown in FIG. 6, the inductances on the coils of each stage must be different, and this circuit can only be used for an even number of lamps.

### SUMMARY OF THE INVENTION

One object of the present invention is to provide a lamp load-sharing circuit, in which winding coils on one side of a plurality of transformers are connected to a plurality of lamps, and winding coils on the other side of the transformers are serially connected together to form a closed loop. The same current flows through the winding coils, which are serially connected together to form a closed loop. Through the electromagnetic induction characteristic of the transformers, equal working currents are generated at the lamps connected to the winding coils on the other side of the transformers.

In one embodiment of the present invention, one end of each of a plurality of lamps is connected to a power source, another end of each of the lamps is connected to winding coils on one side of a plurality of transformers, and winding coils on the other side of the transformers are serially connected together to form a closed loop. The power source can thus provide equal working currents for the lamps.

In another embodiment of the present invention, one end of each of a plurality of lamps is connected together, another end of each of the lamps is connected to one end of each of winding coils on one side of a plurality of transformers, another end of each of the winding coils on this side of the transformers is connected to a power source, and winding coils on the other side of the transformers are serially connected together to form a closed loop. The power source can thus provide equal working currents for the lamps.

In yet another embodiment of the present invention, one end of each of a plurality of lamps is connected to one end of each of winding coils on one side of a plurality of transformers in a first set of transformers, another end of each of the winding coils on this side of transformers in the first set of transformers is connected to a first power source, winding coils on the other side of the transformers in the first set of transformers are serially connected together to form a closed loop, another end of each of the lamps is connected to one end of each of winding coils on one side of a plurality of transformers in a second set of transformers, another end of each of the winding coils on this side of the transformers in the second set of transformers is connected to a second power source, and winding coils on the other side of the transformers in the second set of transformers are serially connected together to form a closed loop. The first power source and the second power source can thus provide equal working currents for the lamps.

The present invention makes use of the electromagnetic induction characteristic of transformers. Through the closed loop is formed by serially connecting winding coils on one side of the transformers, the same current flows through winding coils at this side, hence providing equal working currents for lamps connected to winding coils on the other side of the transformers. Moreover, the present invention can be used for balance and uniformity of current of an odd or even number of lamps.

The various objects and advantages of the present invention will be more readily understood from the following detailed description when read in conjunction with the appended drawing, in which:

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a diagram of a conventional simple circuit making use of a differential ballast to regulate the currents of two lamps;

FIG. 2 is an equivalent magnetic circuit diagram of the transformer in FIG. 1;

FIG. 3 is a diagram showing how the equivalent magnetic circuit in FIG. 1 is connected to the lamps;

FIG. 4 is a diagram of another conventional simple circuit making use of differential ballasts to regulate the currents of a plurality of lamps;

FIG. 5 is a diagram of yet another conventional simple circuit making use of a differential ballast to regulate the currents of two lamps;

FIG. 6 is a diagram of still yet another conventional simple circuit making use of differential ballasts to regulate the currents of a plurality of lamps;

FIG. 7 is a circuit diagram of a two-lamp load-sharing circuit of the present invention;

FIG. 8 is a circuit diagram of a three-lamp load-sharing circuit of the present invention;

FIG. 9 is a circuit diagram of another two-lamp load-sharing circuit of the present invention;

FIG. 10 is a circuit diagram of another three-lamp load-sharing circuit of the present invention; and

FIG. 11 is a circuit diagram of a multiple-lamp load-sharing circuit of the present invention.

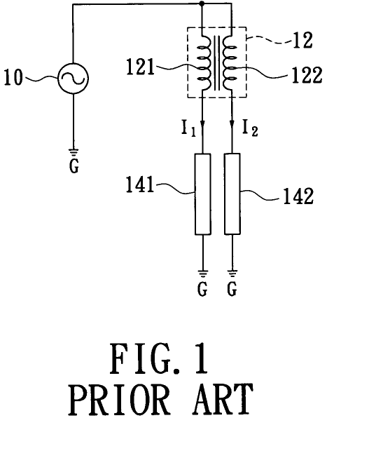

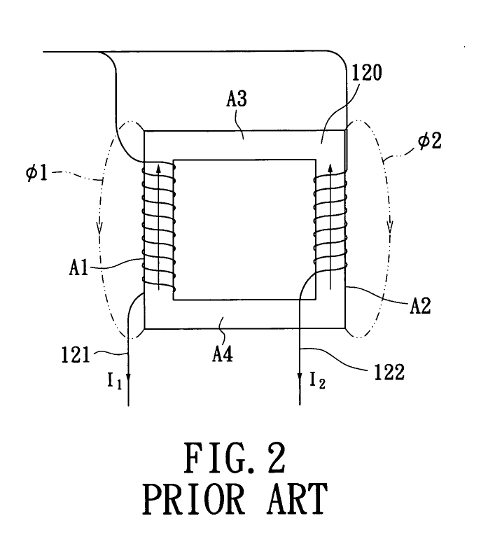

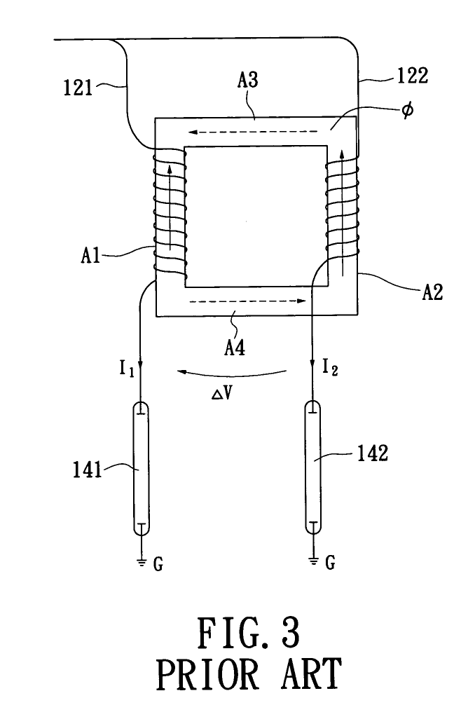

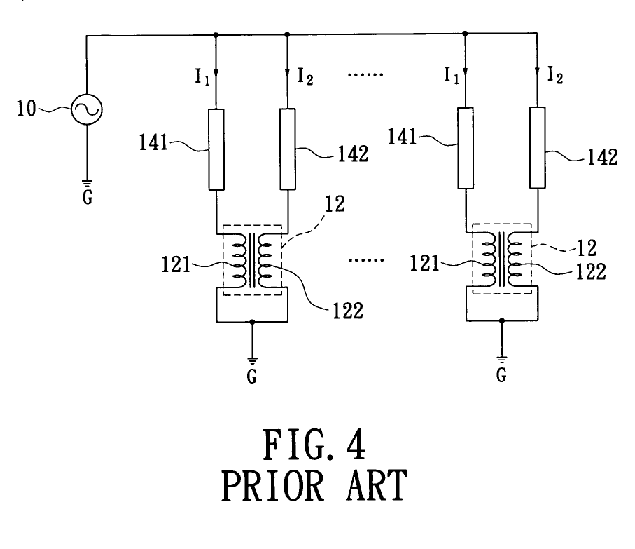

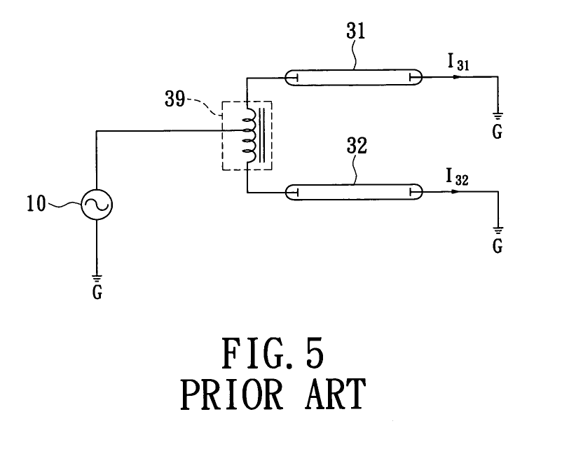

### DETAILED DESCRIPTION OF THE PREFERRED EMBODIMENTS

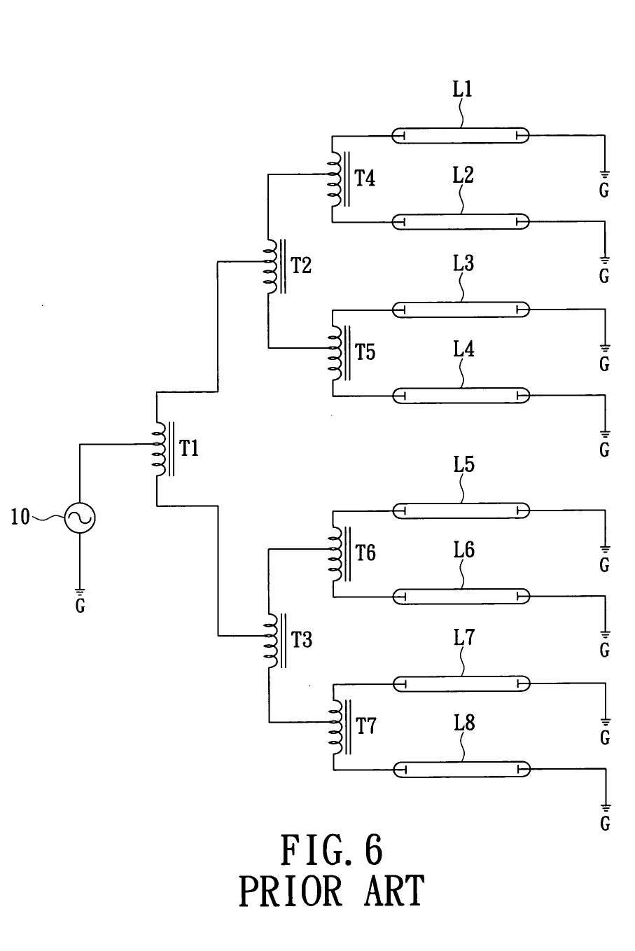

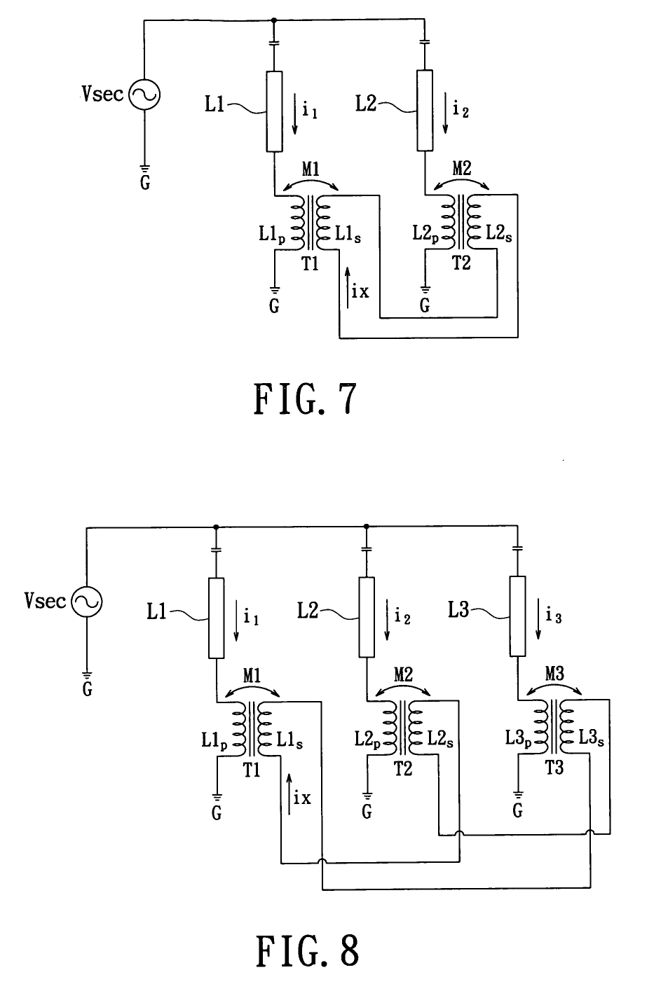

FIG. 7 is a circuit diagram of a two-lamp load-sharing circuit of the present invention. The circuit comprises two lamps L1 and L2. One end of each of the two lamps L1 and L2 is connected to a power source Vsec, and another end of each of the lamps L1 and L2 is connected to winding coils L1ₚ and L2ₚ on one side of two transformers T1 and T2. Winding coils L1ₛ and L2ₛ on the other side of the transformers T1 and T2 are serially connected together to form a closed loop. Through the electromagnetic induction characteristic of the transformers T1 and T2 and the closed loop formed by serially connecting the winding coils L1ₛ and L2ₛ on one side of the transformers T1 and T2, the same current ix flows through the winding coils L1ₛ and L2ₛ on this side of the transformers T1 and T2. The power source Vsec thus provides equal working currents i₁ and i₂ for the lamps L1 and L2. The numbers of turns of the winding coils on two sides of the transformers T1 and T2 are equal, and the transformers T1 and T2 are equally balanced transformers. The lamps L1 and L2 can be cold cathode fluorescent lamps (CCFLs) or external electrode fluorescent lamps (EEFLs).

Reference is made to FIG. 7 again. The transformers T1 and T2 are balanced transformers. The numbers of turns of the winding coils on two sides of the transformer T1 are equal (N1ₚ=N1ₛ). The numbers of turns of the winding coils on two sides of the transformer T2 are equal (N2ₚ=N2ₛ). Therefore, the equivalent inductances on the winding coils on two sides of the transformers are equal:
L1ₚ=L1ₛ; L2ₚ=L2ₛ (1)
where L1ₚ and L1ₛ represent the equivalent inductances on the winding coils of the transformer T1, respectively, and L2ₚ and L2ₛ represent the equivalent inductances on the winding coils of the transformer T2, respectively. If the numbers of turns of the transformers T1 and T2 are also equal, then:
L1ₚ=L1ₛ=L2ₚ=L2ₛ (2)

Because the equivalent inductances on the winding coils of the transformers T1 and T2 are equal, the mutual inductances M1 and M2 generated between the winding coils on two sides of the transformers T1 and T2 are approximately equal:
M1=M2 (3)
where M1 is the mutual inductance between the winding coils on two sides of the transformer T1, and M2 is the mutual inductance between the winding coils on two sides of the transformer T2.

Reference is made to FIG. 7 again. The voltage of the power source Vsec can be calculated through the internal resistances Z1 and Z2 of the lamps L1 and L2 and the working currents i₁ and i₂, the equivalent inductances L1ₚ and L2ₚ of the winding coils on one side of the transformers T1 and T2, the mutual inductances M1 and M2 generated between the winding coils on two sides of the transformers T1 and T2, and the current ix flowing through the winding coils L1ₛ and L2ₛ on the other side of the transformers T1 and T2:
V_{sec}=(Z1+jωL1ₚ)·i₁−ix(jωM1) (4)
V_{sec}=(Z2+jωL2ₚ)·i₂−ix(jωM2) (5)
where ω is the working angular frequency of the power source Vsec.

From equations (4) and (5), we obtain:
(Z1+jωL1ₚ)·i₁−ix(jωM1)=(Z2+jωL2ₚ)·i₂−ix(jωM2) (6)

After rearrangement of equation (6), the working current i₁ can be calculated by the following equation:

$${i}_{1} = \frac{( Z2 + j ω {L2}_{p} )}{Z1 + j ω {L1}_{p}} \cdot {i}_{2} - \frac{( ix ( j ω M2 ) - ix ( j ω M1 ) )}{Z1 + j ω {L1}_{P}} \qquad ( 7 )$$

Reference is made to equation (7). Because the mutual inductances M1 and M2 generated between the winding coils on two sides of the transformers T1 and T2 are equal (M1=M2), the working current ii in equation (7) can be expressed as follows:

$${i}_{1} = \frac{( Z2 + j ω {L2}_{p} )}{Z1 + j ω {L1}_{p}} \cdot {i}_{2} \qquad ( 8 )$$

From rearrangement of equations (2) and (8), the following equation can be obtained:

$$\frac{{i}_{1}}{{i}_{2}} = \frac{( Z2 + j ω {L1}_{p} )}{( Z1 + j ω {L1}_{p} )} \qquad ( 9 )$$

From equation (9), when the internal resistances Z1 and Z2 of the lamps L1 and L2 are equal can be predicted, and the working current i₁ of the lamp L1 is equal to the working current i₂ of the lamp L2 (i₁=i₂). If the internal resistances Z1 and Z2 of the lamps L1 and L2 are not equal but are much smaller than jωL1ₚ, the working currents i₁ and i₂ are almost equal (i₁=i₂).

As illustrated above, the present invention makes use of the electromagnetic induction characteristic of transformers. Through the closed loop formed by serially connecting the winding coils on one side of the transformers T1 and T2, the same current ix flows through the winding coils on this side of the transformers T1 and T2, hence providing equal working currents i₁ and i₂ for the lamps L1 and L2 connected to the winding coils on the other side of the transformers T1 and T2 to accomplish the balance and uniformity of the working currents i₁ and i₂ of the lamps L1 and L2. Moreover, the present invention can improve the problem that different inductances are generated on coils at each stage in the conventional circuit, which is only applicable to an even number of lamps. The present invention can be used for an odd or even number of lamps.

FIG. 8 is a circuit diagram of a three-lamp load-sharing circuit of the present invention. The circuit comprises three lamps (L1, L2, L3). One end of each of the three lamps (L1, L2, L3) are connected to a power source Vsec, and another end of each of the lamps (L1, L2, L3) are connected to winding coils (L1ₚ, L2ₚ, L3ₚ) on one side of three transformers (T1, T2, T3). Winding coils (L1ₛ, L2ₛ, L3ₛ) on the other side of the transformers (T1, T2, T3) are serially connected together to form a closed loop. Through the electromagnetic induction characteristic of the transformers (T1, T2, T3) and the closed loop formed by serially connecting the winding coils (L1ₛ, L2ₛ, L3ₛ) on one side of the transformers (T1, T2, T3), the same current ix flows through the winding coils (L1ₛ, L2ₛ, L3ₛ) on this side of the transformers (T1, T2, T3). The power source Vsec thus provides equal working currents (i₁, i₂, i₃) for the lamps (L1, L2, L3). The numbers of turns of the winding coils on two sides of the transformers (T1, T2, T3) are equal, and the transformers (T1, T2, T3) are equally balanced transformers. The lamps (L1, L2, L3) can be cold cathode fluorescent lamps (CCFLs) or external electrode fluorescent lamps (EEFLs).

Reference is made to FIG. 8 again. The principle and derivation of governing equations of the three-lamp load-sharing circuit in FIG. 8 are the same as those of the two-lamp load-sharing circuit in FIG. 7 and thus are not be described further. The present invention can improve the problem that different inductances are generated on coils at each stage in the conventional circuit, which is only applicable to an even number of lamps. The present invention can be used for an odd or even number of lamps to provide uniformity and balance of current.

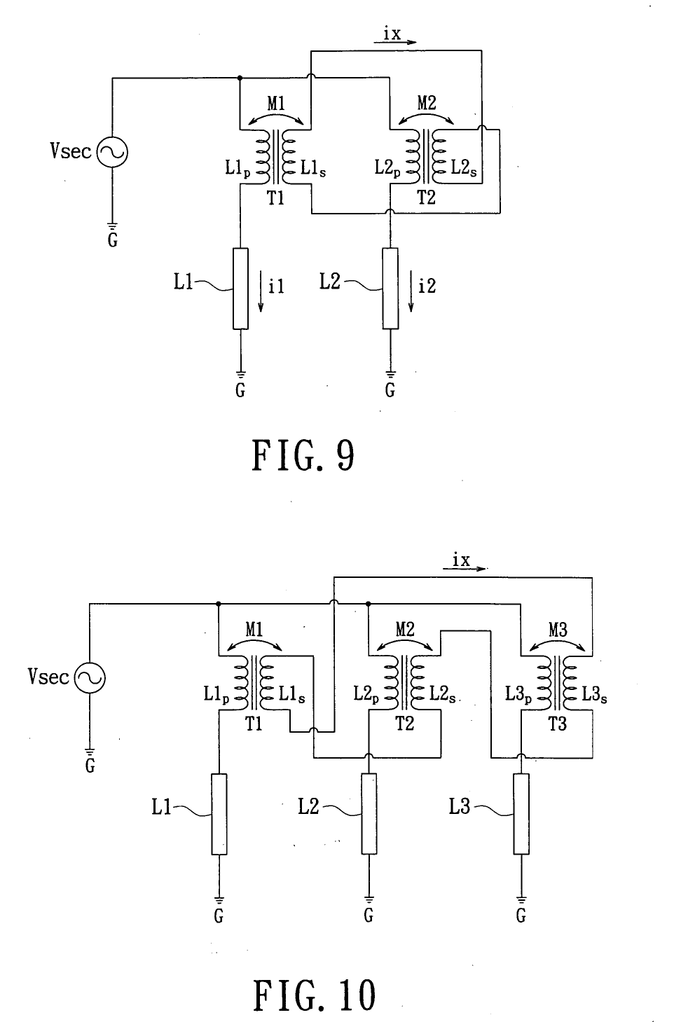

FIG. 9 is a circuit diagram of another two-lamp load-sharing circuit of the present invention. The circuit comprises two lamps (L1, L2). One end of each of the lamps (L1, L2) is connected to a reference terminal G, and another end of each of the lamps (L1, L2) is connected to a power source Vsec via winding coils (L1p, L2p) on one side of two transformers (T1, T2). Winding coils (L1s, L2s) on the other side of the transformers (T1, T2) are serially connected together to form a closed loop. Through the electromagnetic induction characteristic of the transformers (T1, T2) and the closed loop formed by serially connecting the winding coils (L1ₛ, L2ₛ) on one side of the transformers (T1, T2), the same current ix flows through the winding coils (L1ₛ, L2ₛ) on this side of the transformers (T1, T2). The power source Vsec thus provides equal working currents (i₁, i₂) for the lamps (L1, L2). The numbers of turns of the winding coils on two sides of the transformers (T1, T2) are equal, and the transformers (T1, T2) are equally balanced transformers. The lamps (L1, L2) can be cold cathode fluorescent lamps (CCFLs) or external electrode fluorescent lamps (EEFLs).

FIG. 10 is a circuit diagram of another three-lamp load-sharing circuit of the present invention. The circuit comprises three lamps (L1, L2, L3). One end of each of the three lamps (L1, L2, L3) is connected to a reference terminal G, and another end of each of the lamps (L1, L2, L3) is connected to a power source Vsec via winding coils (L1ₚ, L2ₚ, L3ₚ) on one side of three transformers (T1, T2, T3). Winding coils (L1ₛ, L2ₛ, L3ₛ) on the other side of the transformers (T1, T2, T3) are serially connected together to form a closed loop. Through the electromagnetic induction characteristic of the transformers (T1, T2, T3) and the closed loop formed by serially connecting the winding coils (L1ₛ, L2ₛ, L3ₛ) on one side of the transformers (T1, T2, T3), the same current ix flows through the winding coils (L1ₛ, L2ₛ, L3ₛ) on this side of the transformers (T1, T2, T3). The power source Vsec thus provides equal working currents (i₁, i₂, i₃) for the lamps (L1, L2, L3). The numbers of turns of the winding coils on two sides of the transformers (T1, T2, T3) are equal, and the transformers (T1, T2, T3) are equally balanced transformers. The lamps (L1, L2, L3) can be cold cathode fluorescent lamps (CCFLs) or external electrode fluorescent lamps (EEFLs).

Reference is made to FIGS. 9 and 10 again. The principle and derivation of governing equations of the load-sharing circuits in FIGS. 9 and 10 are the same as those of the two-lamp load-sharing circuit in FIG. 7 and thus are not described further. The present invention can improve the problem that different inductances are generated on coils at each stage in the conventional circuit, which is only applicable to an even number of lamps. The present invention can be used for an odd or even number of lamps to provide uniformity and balance of current.

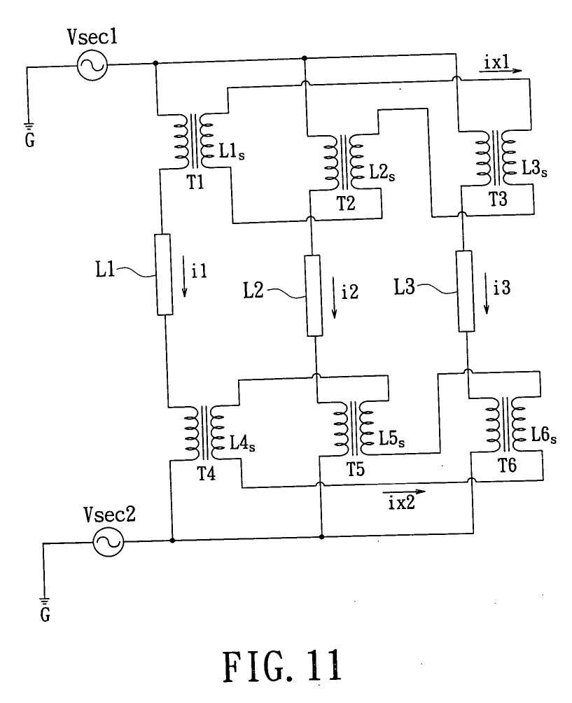

FIG. 11 is a circuit diagram of a multiple-lamp load-sharing circuit of the present invention. This circuit is based on the principle of a floating circuit to input a reverse voltage across two ends of a lamp to turn on the lamp. This embodiment is exemplified with three lamps. Each of three lamps (L1, L2, L3) has two ends. One end of each of the three lamps (L1, L2, L3) is connected to a first power source Vsec1 via winding coils on one side of three transformers (T1, T2, T3). Winding coils on the other side of the transformers (T1, T2, T3) are serially connected together to form a closed loop. Another end of each of the lamps (L1, L2, L3) are connected to a second power source Vsec2 via winding coils on one side of three transformers (T4, T5, T6). Winding coils on the other side of the transformers (T4, T5, T6) are serially connected together to form a closed loop. The transformers T1, T2, and T3 form a first set of transformers, while the transformers T4, T5, and T6 form a second set of transformers.

Through the electromagnetic induction characteristic of the transformers (T1, T2, T3, T4, T5, T6) and the closed loops formed by serially connecting the winding coils (L1ₛ, L2ₛ, L3ₛ, L4ₛ, L5ₛ, L6ₛ) on one side of the transformers (T1, T2, T3, T4, T5, T6), the same currents ix1 and ix2 flow through the winding coils (L1ₛ, L2ₛ, L3ₛ, L4ₛ, L5ₛ, L6ₛ) on this side of the transformers (T1, T2, T3, T4, T5, T6). The first power source Vsec 1 and the second power source Vsec2 thus provide equal working currents (i₁, i₂, i₃) for the lamps (L1, L2, L3). The numbers of turns of the winding coils on two sides of the transformers (T1, T2, T3, T4, T5, T6) are equal, and the transformers (T1, T2, T3, T4, T5, T6) are equally balanced transformers. The lamps (L1, L2, L3) can be cold cathode fluorescent lamps (CCFLs) or external electrode fluorescent lamps (EEFLs).

The above illustrations are exemplified with two and three lamps. If the present invention is applied to other number of lamps, the circuit connection way can be modified to increase or decrease the number of lamps. Moreover, the circuit principle is the same as stated above.

Reference is made to FIG. 11 again. The principle and derivation of governing equations of the load-sharing circuits in FIG. 11 are the same as those of the load-sharing circuits in FIGS. 7 and 8 and thus are not described further. The present invention can improve the problem that different inductances are generated on coils at each stage in the conventional circuit, which is only applicable to an even number of lamps. The present invention can be used for an odd or even number of lamps to provide uniformity and balance of current.

To sum up, the present invention proposes a lamp load-sharing circuit, which makes use of the electromagnetic induction characteristic of transformers and the closed loop formed by serially connecting winding coils on one side of the transformers to let the same current flow through the winding coils on this side of the transformers. The power source thus provides equal working currents for lamps connected to winding coils on the other side of the transformers. The present invention can improve the problem that different inductances are generated on coils at each stage in the conventional circuit, which is only applicable to an even number of lamps. The present invention can be used for an odd or even number of lamps to accomplish the uniformity and balance of current.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A lamp load-sharing circuit comprising:
a plurality of lamps, wherein one end of each lamp is connected to a power source; and
a plurality of transformers, wherein winding coils thereof on one side are connected to another end of each of said lamps and winding coils on another side are serially connected together to form a closed loop;
whereby said power source provides identical working currents for said lamps.

2. The lamp load-sharing circuit as claimed in claim 1, wherein a number of said lamps is odd or even.

3. The lamp load-sharing circuit as claimed in claim 1, wherein said lamps are cold cathode fluorescent lamps or external electrode fluorescent lamps.

4. The lamp load-sharing circuit as claimed in claim 1, wherein said winding coils of said transformers have identical numbers of turns.

5. A lamp load-sharing circuit, comprising:
a plurality of lamps, wherein one end of each lamp is connected to one end of another lamp; and
a plurality of transformers, wherein one end of each winding coil on one side is connected to another end of each of said lamps, other ends of said winding coils at said side are connected to a power source, and winding coils on another side are serially connected together to form a closed loop;
whereby said power source provides identical working currents for said lamps.

6. The lamp load-sharing circuit as claimed in claim 5, wherein a number of said lamps is odd or even.

7. The lamp load-sharing circuit as claimed in claim 5, wherein said lamps are cold cathode fluorescent lamps or external electrode fluorescent lamps.

8. The lamp load-sharing circuit as claimed in claim 5, wherein said winding coils of said transformers have identical numbers of turns.

9. A lamp load-sharing circuit, comprising:
a plurality of lamps, each having two ends;
a first set of transformers having a plurality of transformers, one end of each of winding coils on one side of said transformers being connected to one end of each of said lamps and another end of each of said winding coils at said side of said transformers being connected to a first power source, winding coils on the other side of said transformers being serially connected together to form a closed loop; and
a second set of transformers having a plurality of transformers, one end of each winding coil on one side of said transformers being connected to one end of each of said lamps and another end of each of said winding coils on said side of said transformers being connected to a second power source, winding coils on the other side of said transformers being serially connected together to form a closed loop;
whereby said first and second power sources provide identical working currents for said lamps.

10. The lamp load-sharing circuit as claimed in claim 9, wherein a number of said lamps is odd or even.

11. The lamp load-sharing circuit as claimed in claim 9, wherein said lamps are cold cathode fluorescent lamps or external electrode fluorescent lamps.

12. The lamp load-sharing circuit as claimed in claim 9, wherein said winding coils of said transformers have identical numbers of turns.
